(19) United States
(12) Patent Application Publication
(10) Pub. No.: US 2003/0156715 A1
(43) Pub. Date: Aug. 21, 2003

(54) Apparatus, system and method for validating integrity of transmitted data

(76) Inventors: James Alexander Reeds III, New Providence, NJ (US); Wen-Ping Ying, Bellevue, WA (US)

Correspondence Address: Terrance A. Meador, Gary, Cary, Ware & Freidenrich, 4365 Executive Drive,, Suite 1100, San Diego,, CA, 92121-2133, US

(21) Appl. No.: 09/879,575

(22) Filed: Jun. 12, 2001

(51) Int. Cl. H04L 9/00

(52) U.S. Cl. 380/37

(57) ABSTRACT

An apparatus, system and method maintain synchronization of an encryption key stream at the transmitter to a decryption key stream at a receiver. The transmitter applies a portion of a fixed segment of the continuous encryption key stream to data to form an encrypted payload. At least a portion of a session count is combined with the encrypted payload to form an encrypted data packet. The receiver decrypts the encrypted data packet by applying a portion of a current fixed segment of a continuous decryption key stream to the encrypted payload if the difference between a received session count and locally generated session count is less than a threshold. Otherwise, the packet is discarded and the system is reset. Since fixed length segments of the encryption key streams are dedicated to each packet, synchronization of the key streams is maintained even if synchronization for a particular packet is lost.

### BACKGROUND OF THE INVENTION

The invention relates in general to communication systems and more specifically to methods and systems for validating the integrity of transmitted data.

Conventional communication systems utilize encryption or encipherment techniques for several purposes including authentication, key distribution, secure data transmissions and non-repudiation. Data is often encrypted using a key, transmitted through a communication channel, and decrypted (deciphered) at a receiver using another key. Encryption provides security by using an encryption code to mask the data contained in a transmission. A decryption code is used at the receiving end to decode or decrypt the transmitted message to obtain the original data. The decryption code used at the receiving end, however, must be applied to the incoming transmitted data stream in an appropriate timing and order. If the decryption code is not synchronized to the encryption code, the data cannot be decrypted properly. In order to maintain accurate reception of data, techniques are used to detect an out-of-synchronization situation where the system determines that the decryption code is not properly being applied to the incoming data.

Although encryption methods may provide for secrecy for the transmitted data by requiring a key to decode the message, encryption does not necessarily prevent tampering of the data by third parties. Further, encryption does not always provide an indication that the data has not been received as transmitted. For many encryption schemes, the integrity of the transmitted data must be validated using an additional mechanism or process.

Message digests are used to secure the integrity of data but do not typically provide secrecy. Message digest methods allow a communication system to determine whether a data in a transmitted message has been manipulated or corrupted, either intentionally by an unscrupulous party or due to system errors. In one such message digest method, a hash function is applied to a bit string allowing a message digest, also known as checksum, to be calculated based on the bit string. A checksum or message digest is data used for error checking. The checksum is calculated by the sending computer based on an algorithm that counts bits going out in a packet. The check digit is attached as a tail to the packet. As the packet is received, the receiving computer applies the same algorithm and if the calculated check digit is the same as the one received, the transmission is determined to be successful. In addition to corruption and tampering, a mismatch may indicate that the message digest has been applied incorrectly. For example, a mismatch will occur if the encryption codes are not synchronized.

Conventional systems do not utilize transmission bandwidth efficiently to provide out-of-synchronization and data integrity detection. In many communication systems, transmission bandwidth is inefficiently used by transmitting synchronization information through the communication channel. In these systems, the level of integrity of the data increases with the use of bandwidth. In other words, larger or longer message digests result in more robust systems at the cost of valuable bandwidth.

### SUMMARY OF THE INVENTION

What is needed in the art is a system and method of minimizing the use of bandwidth to provide data integrity validation and real-time synchronization of cipher streams at the transmitter and receiver. The present invention provides a system and method of using a minimal amount of bandwidth in data integrity validation and cipher stream synchronization.

In an exemplary embodiment of the invention, a transmitter applies a portion of a fixed length segment of a continuous encryption key stream to data to encrypt data and form an encrypted payload. At least a portion of a session count corresponding to the fixed length segment is combined with the encrypted payload to form an encrypted data packet that is transmitted to a receiver through a communication channel. The receiver expands the received portion of the session count to a full length session count and compares it to a locally generated session count. If the difference between the two values is less than a threshold, the receiver decrypts the encrypted payload by applying a portion of fixed length segment of a continuous decryption key stream to the received encrypted payload. The fixed length segment corresponds to the session count and the decryption key stream can be the same as the encryption key stream. Synchronization is maintained by tracking the session count and dedicating fixed length segments of the encryption and decryption key streams to each packet regardless of the length of the payload.

### BRIEF DESCRIPTION OF THE DRAWINGS

FIG. 1 is a block diagram of a communication system in accordance with an exemplary embodiment of the invention.

FIG. 2 is block diagram of a protocol stack in accordance with the exemplary embodiment of the invention.

FIG. 3 is a block diagram of a transmitter in accordance with the exemplary embodiment of the invention.

FIG. 4 is a block diagram of a receiver in accordance with the exemplary embodiment of the invention.

FIG. 5a is a flow chart of a method of transmitting a signal in accordance with the exemplary embodiment of the invention.

FIG. 5b is a flow chart of an exemplary method of performing step 502.

FIG. 6 is a flow chart of a method of receiving a signal in accordance with the exemplary embodiment of the invention.

### DETAILED DESCRIPTION OF THE PREFERRED EMBODIMENTS

As discussed above, conventional communication systems employ inefficient encryption schemes that waste bandwidth to provide a mechanism to detect a loss of synchronization between encryption and decryption stream ciphers. Cryptographic methods using stream ciphers require that the transmitter and receiver stay in synchronization. Conventional systems require additional information to be transmitted with the encrypted payload allowing a receiver to detect a loss of synchronization based on the additional information. Unfortunately, the additional information requires additional valuable bandwidth. Further, conventional systems often require the use of complex message digest or checksum generators to provide the additional information which requires additional computational requirements to the system. Further, some conventional systems transmit encrypted padded data to maintain real-time synchronization between the transmitter and receiver cipher key streams which results in inefficient use of bandwidth limited communication resources

In the exemplary embodiment of the invention, the receiver validates the integrity of received data and provides real-time stream cipher synchronization. Fixed length segments of continuous encryption and decryption key streams are dedicated to each data packet regardless of the size of the packet. By tracking the session count (or packet count) of the data packet, the synchronization between the encryption and decryption key streams can be maintained.

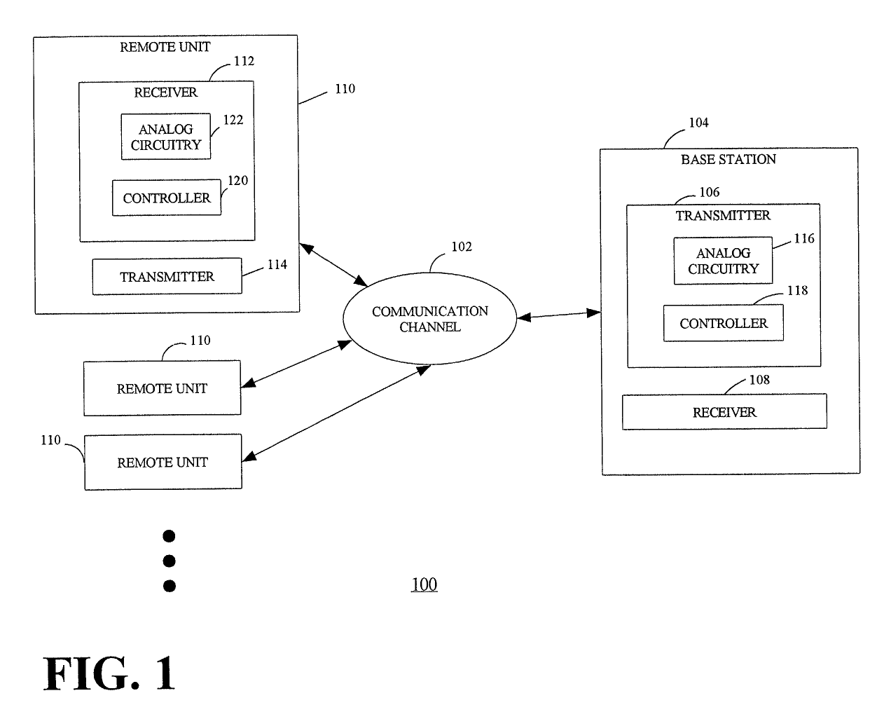

FIG. 1 is a block diagram of communication system 100 suitable for implementing the exemplary embodiment of the invention. The communication system 100 is a fixed wireless system providing communication services to subscriber premises through a communication channel 102. A base station 104 includes a transmitter 106 and a receiver 108 in addition to other circuitry, hardware and software (not shown) required to perform the functions described herein. A remote unit 110 located at the subscriber premises includes a receiver 112 for receiving signals transmitted from the transmitter 106 in the base station 104 and a transmitter 114 for transmitting signals to the receiver 108 at the base station 104. The communication system 100 may include several remote units 110 and may have any one of a variety of configurations. As discussed below in further detail, data to be received by the remote unit 110 is encrypted in the base station 104 and transmitted through a wireless communication channel 102. Although the communication system 100 is a fixed wireless system in the exemplary embodiment, those skilled in the art will recognize that the teachings herein can be applied to other types of communication systems and the present invention is not limited to wireless systems or wireless communication channels.

In addition to analog circuitry 116 such as antennas, amplifiers, mixers, control circuits and other components, the transmitter 106 within the base station 104 includes a controller 118 such as a processor, microprocessor or any other processor arrangement. Software code running on the controller 118 facilitates the overall functionality of the transmitter 106 in addition to the encryption and transmission functions described herein. As is known, circuitry within the transmitter 106 may be implemented as part of the receiver 108. The controller 118, for example, may facilitate the operation of the receiver 108 in the base station 104. In the exemplary embodiment, data is transmitted from the base station 104 to the remote units 110 on the forward communication channel and from the remote units 110 to the base station 104 on the reverse communication channel. Based on the discussion in regard to the transmission of data from the base station 104 to the remote unit 110, those skilled in the art will readily apply the teachings herein to the communication link from the remote unit 110 to the base station 104. Accordingly, in the interest of brevity, the discussion below is limited to the forward communication link from the base station 104 to the remote unit 110.

The receiver 112 in the remote unit 110 includes a controller 120 in addition to analog circuitry 122 such as antennas, amplifiers, mixers, control circuits and other components. The controller 120 may be a processor, microprocessor or any other processor arrangement or combination suitable for running software code that facilitates the overall functionality of the remote unit 110 in addition to the decryption and receiver functions described herein. The controller 120, for example, may facilitate the operation of the transmitter 114 in addition to other tasks in the remote unit 110.

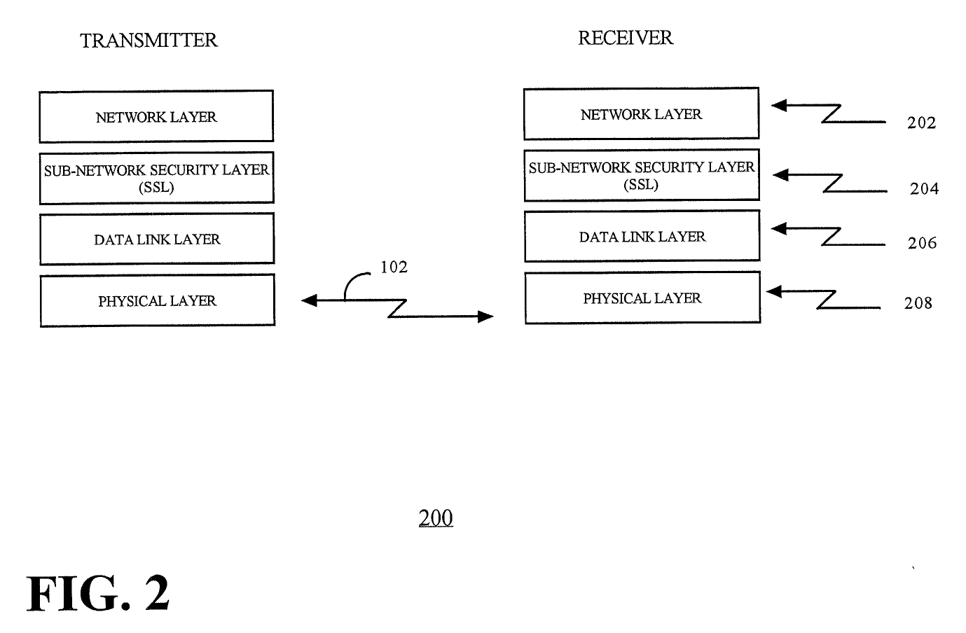

FIG. 2 is a block diagram illustrating a communication protocol stack 200 in accordance with the exemplary embodiment of the invention. As is known, communication systems typically employ a network architecture that includes a set of several levels or layers that operate together. Control is passed from each layer to the next starting at the highest level and proceeding through the hierarchy to the lowest or bottom layer. Those skilled in the art will readily recognize the various alternate network layer schemes that can be used in accordance with the invention and the various terminology that can used to refer to the various layers (202-208) in a communication protocol stack 200. For example, the set of layers (202-208) and interfaces between layers (202-208) is often referred to as a network architecture or protocol hierarchy which can contain any number of layers and organizations depending on the particular communication system 100.

In the exemplary embodiment, the communication protocol stack 200 includes at least a network layer 202, a sub-network security layer (SSL) 204, a data link layer 206, and physical layer 208. The communication protocol stack 200, however, may include any number of layers (202-208) or sub-layers depending on the particular communication system 100. Layers which are higher on the hierarchy of the protocols are referred to as upper layers while layers relatively lower than other layers are referred to as lower layers or sub-layers. Therefore, the network layer 202 is an upper layer while the SSL 204 is a lower layer as compared to the network layer 202 and any other layer above the network layer 202. The network layer 202 provides internetworking for a communication session. The SSL layer 204 facilitates the security of the communications. The data link layer 206 provides the transmission of a data packet from the transmitter 106 to the receiver 112 while the physical layer 208 provides the transmission of the bits over the communication channel 102.

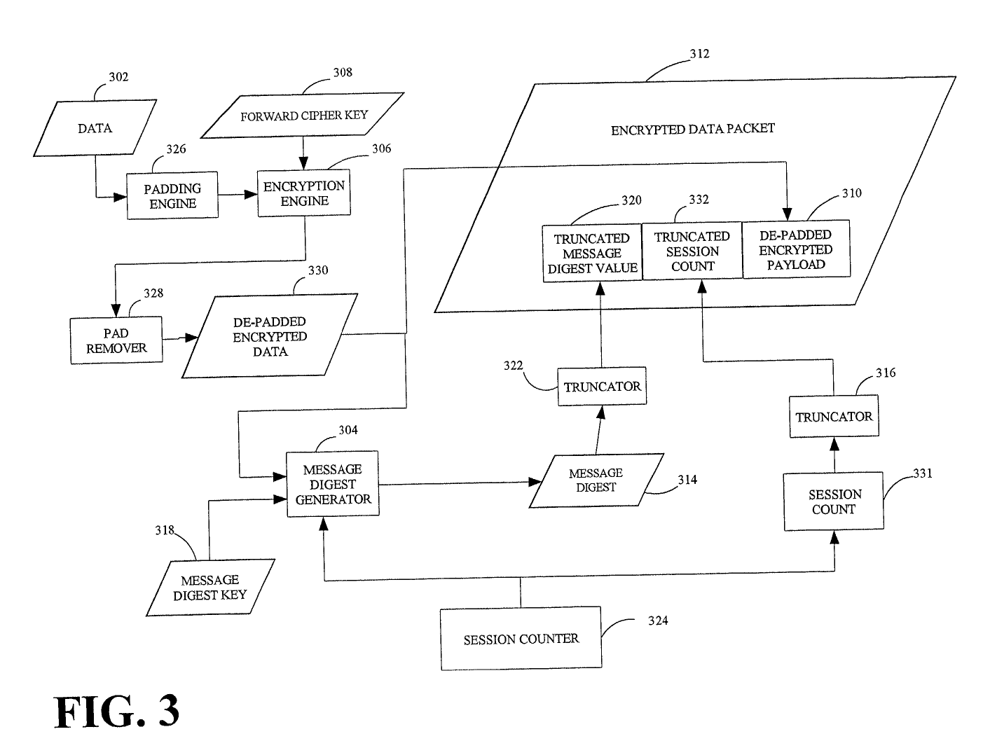

FIG. 3 is a pictorial representation of a data flow of the data packet formation process performed in the transmitter 106. In the exemplary embodiment, a similar procedure is performed at the remote unit 110 for data 302 that is transmitted from the remote unit 110 to the base station 104. As discussed above, the encryption and data integrity validation techniques can be applied to a variety of communication and data systems 100. The data packet generation process utilizes a session counter 324, a message digest generator 304 and an encryption engine 306 in the exemplary embodiment. Although in the exemplary embodiment the encryption, message digest, padding and other functions are performed using software code running on the controller 120, the various functional blocks described below may be implemented either solely in or in any combination of hardware, software, or firmware.

As described below in further detail, data 302 to be transmitted from the transmitter 106 to the receiver 112 is received at an encryption engine 306 after being padded to a maximum length in a padding engine 326. The encrypted data is returned to its original length in a pad remover 328 after encryption in the encryption engine 306. A message digest value 314 is generated based on the de-padded encrypted data 330, a message digest key 318 and a session count generated by the session counter 324. An encrypted data packet 312 is formed to include the truncated message digest value 320, the truncated session count 332 and the de-padded encrypted payload 310. The encrypted data packet 312 includes at least a portion of a message digest value 314, a portion of a session count 331 and encrypted data. Although in the exemplary embodiment truncated versions of the session count 331 (truncated session count 332) and the message digest value 314 (truncated message digest value 320) are used, the complete message digest value 314 and the complete session count 331 can be used at the expense of bandwidth.

The data 302 to be transmitted from the base station 104 to the remote unit 110 may include a variety of information or control messages and is received at the security sub-layer (SSL) 204 as a continuous bit stream in the exemplary embodiment. The data 302, however, may be received in a variety of formats. For example, the raw data 302 may be arranged into packets or may include some level of error correction.

The data 302 is received from an upper layer at the SSL layer 204 and padded in the padding engine 326. The padding engine 326 in the exemplary embodiment appends a specified set of bits to the data 302 in order to form a data string having a maximum length in accordance with the system protocols. Accordingly, all data strings presented to the encryption engine 306 are the same maximum length.

In the exemplary embodiment, the encryption engine 306 uses RC4 cipher stream encryption techniques to apply a forward cipher key 308 to the padded data to produce the encrypted padded payload. The encryption engine 306, however, may use any other suitable stream cipher or block cipher encryption technique. Examples of other cipher stream techniques include exclusive-or or modular addition with the output of a linear feedback shift register and block ciphers used in an output feedback mode or counter mode. Although many block cipher techniques may have some level of data integrity validation inherit to the block cipher encryption scheme, the present invention may be utilized with block ciphers that may or may not have additional or inherent data validation mechanisms. Examples of suitable block ciphers include DES, 3DES, IDEA, Skipjack, FEAL, and AES. Since, after padding, each data string presented to the encryption engine 306 is the same length, the length of the section of the forward cipher key 308 (encryption key stream) that is dedicated to each data packet 312 is identical.

After encryption, the encrypted data string is reduced to its original size by the pad remover 328 to produce de-padded encrypted data 330. The number of bits added by the padding engine 326 are removed from the encrypted payload to form the de-padded encrypted data packet 330. Since the encryption key stream 308 is applied bit per bit to the data, no information is lost by removing the encrypted bits resulting from the added bits of the pad.

The functions of the padding engine 326, encryption engine 306 and pad remover 328 result in a utilization of a fixed and consistent length of a section of the encryption key stream 308 independent of the length of the data string. By using the same length of the section of the encryption key stream 308 for each data packet 312, synchronization can be maintained by tracking the session count 331 and applying the appropriate section of encryption key stream 308 to each payload 310. Accordingly, if the session count 331 is known, the data packet 312 can be decrypted even if synchronization has previously been lost. Those skilled in the art will recognize that the padding engine 326, encryption engine 306 and pad remover 328 provide an exemplary description of functions producing the results described herein and other functional blocks can be used to explain the desired outcome. For example, the desired result of using a segment of the forward cipher key 308 having a consistent length to encrypt each data packet 312 can be viewed as applying an appropriate number of bits of a constant length section of forward cipher key 308 to a data packet and discarding the remainder of bits of the constant length segment. In other words, the forward cipher key 308 is applied bit for bit to the data packet 312 for all the bits in the data payload. If the data payload is shorter than the maximum length segment of forward cipher key 308, the additional cipher key 308 bits are not used and the next packet 312 is encrypted starting with the bit following the last bit in the maximum (fixed) length section.

In the exemplary embodiment, the message digest generator 304 performs a hash function in accordance with MD5 techniques using the de-padded encrypted data 330, a message digest key 318 and a session count 331 produced by the session counter 324. As is known, the MD5 message digest technique provides a one-way hash function using an algorithm. A current message digest value 314 is produced by manipulating the de-padded encrypted data 330 to form a fixed string of digits defining a message digest 314. The message digest 314 is used as a checksum to validate the data packet 312 when received at the receiver 112 as discussed below. Other types of hash functions may be used to provide a hash value representing the de-padded encrypted data 330. Examples of other suitable hash functions include SHA-1, MD4, and RIPEMD. Due to increasing speeds of computers and the efforts of unscrupulous individuals, many current security techniques may not provide the same level of security in the future. Accordingly, new message digest techniques are continually being developed to maintain a desired level of security. Those skilled in the art will recognize that the message digest generator 304 and the encryption engine 306 may utilize algorithms and techniques not yet developed in other embodiments of the invention. In the exemplary embodiment, the message digest generator 304 performs the appropriate calculations using the complete bit strings representing the session count 331 and message digest key 318 although only a portion of the session count 331 is used in the encrypted data packet 312.

In the exemplary embodiment, the message digest key 318 is used at the transmitter 114 and the receiver 108 to generate the message digest 314. The message digest key 318 may be generated and communicated to the receiver 108 using any one of several known techniques. For example, the message digest key 318 may be chosen at the beginning of the communication session, as part of a session establishment procedure. Also, the message digest key 318 may be established and implemented within the various devices of the system 100 at the time of manufacturing, installation or service initialization. If a message digest key 318 is chosen at the transmitter, the message digest key 318 is sent to the receiver 108 using a secure channel. For example, a series of message digest keys 318 may be locally stored at the base station 104 and remote unit 110 at the time of installation of the system 100. Further, the message digest key 318 may be transmitted to the receiver 108 through a secure wireless communication channel 102 using encryption and other forms of security techniques.

The current message digest 314 can be calculated using a previous digest message value calculated for a previous set of de-padded encrypted data 330. The previous message digest that can be used for calculating the current message digest 314 can be the message digest 314 immediately preceding the current message digest 314. The previous message digest 314, however, may be a predetermined number of values preceding the current value and may be a dynamically varying number of values preceding the current value.

The current message digest 314 produced by the message digest generator 304 is truncated by the truncator 322. In the exemplary embodiment, the truncator 322 forms a truncated message digest value 320 by extracting the first four bytes of the current message digest 314. A suitable example includes a message digest 314 having a length of 128 bits and a truncated message digest 320 having a length of 32 bits. Those skilled in the art will recognize that other techniques may be used to form a truncated version 320 of the message digest 314. A compression scheme, for example, may be used to form a shorter version of the message digest 314. For example, a cyclic redundancy checksum (CRC) can be used to form the truncated message digest value 320.

The session counter 324 provides a mechanism for tracking the current communication sessions. A communication session can be any suitable identification of the communications between the transmitter 106 and receiver 108. In the exemplary embodiment, the session counter 324 is a packet counter and each session count 331 is a packet count identifying the packet number of each encrypted data packet 312. Examples of other suitable session counts 331 include a fixed number of packet counts. A session count 331, for example, may correspond to ten data packets 312.

In the exemplary embodiment, only a portion of the session count 331 is included in the encrypted data packet 312. A truncator 316 truncates the session count 331 to a truncated session count 332. For example, if the session count 331 is 4 bytes long, the truncated session count 332 may include only the two least significant bytes of the session count. Any suitable selection of bits, however, may be used to form a portion of the session count 331.

The truncated message digest value 320 is appended to a selected payload 310 in addition to a truncated session count 332 to form an encrypted data packet 312. The encrypted data packets 312 are transmitted by the transmitter 106 through the communication channel 102 using the appropriate circuitry within the transmitter 106 in accordance with known techniques.

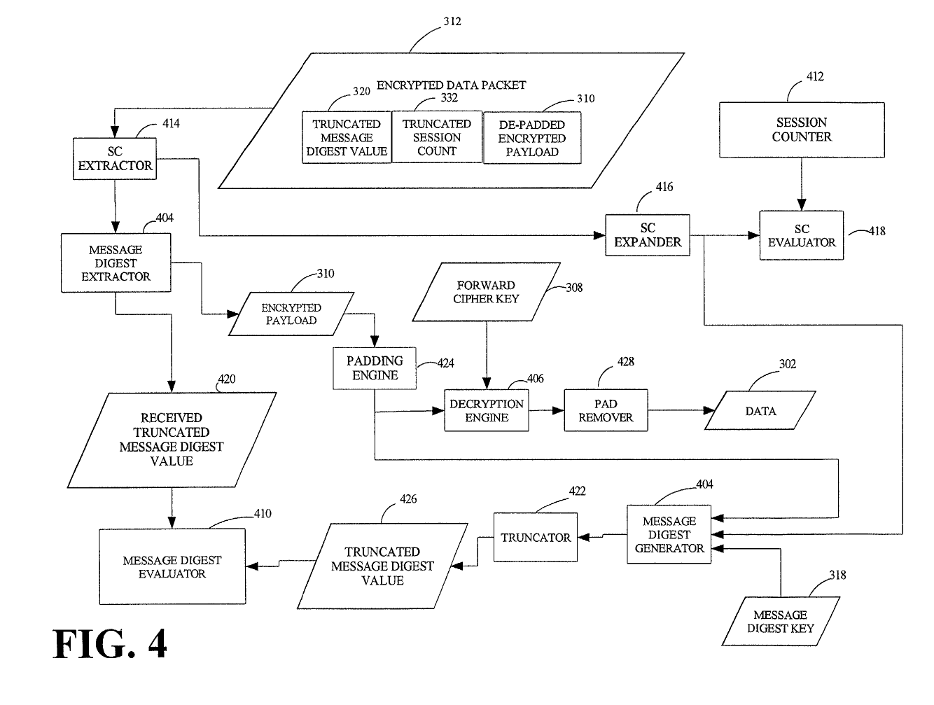

FIG. 4 is pictorial representation of a data flow of the data validation, cipher stream synchronization and decryption processes performed in the receiver 112. As discussed above, the decryption, synchronization and data integrity validation techniques can be applied to a variety of communication and data systems 100. The data integrity validation process utilizes a message digest generator 404, a decryption engine 406 and local session counter 412. Although in the exemplary embodiment the receiver data validation and synchronization functions are performed using software code running on the controller 120 within the receiver 112, the various functional blocks described below may be implemented either solely in or in any combination of hardware, software, or firmware.

The encrypted data packet 312 is received through the communication channel 102 using the appropriate circuitry 120, 122 in the receiver 112 and in accordance with known techniques. A Session Count (SC) extractor 414 extracts the truncated session count 332 from the encrypted data packet 312. The truncated session count 332 is expanded from the truncated 2-byte value to a complete 8-byte value by the SC expander 416. A local session counter 412 within the receiver 108 generates a local session count which is compared to expanded received session count in the SC evaluator 418. In the exemplary embodiment, the SC evaluator 418 is implemented in software running on the controller 120. If the received session count 332 is not within a specified range of the local session count, the data packet 312 is dropped and the system 100 is reset. If the received session count 332 is within the specified range, the receiving procedure continues by evaluating the message digest 320. One suitable method for evaluating the received session count 332 includes performing a subtraction operation between the received and the local session count and comparing the absolute value of the result to a threshold. If the absolute value is less than the threshold, the received session count 332 is determined to be acceptable and the data packet 312 processing continues.

The message digest extractor 404 extracts the received truncated message digest value 320 from the encrypted data packet 312. As explained above, the transmitted data 302 is padded then encrypted and finally reduced to its original size. Accordingly, the received encrypted data 302 is received de-padded encrypted data 320. The encrypted payload 310 is padded to the maximum size by the padding engine 424. The resulting padded encrypted data 302 is used to generate a message digest which is compared to the received message digest. In the exemplary embodiment, since the received message digest is truncated, the locally generated message digest is truncated before it is compared to the received truncated message digest value 410.

After it is determined that the session count 332 is acceptable, the message digest generator 404 generates a message digest based on the complete (expanded) received session count, the received padded encrypted data 302 produced by the padding engine 424 and the message digest key 318.

The message digest is truncated by the truncator 422 to form a truncated message digest value 426 which is compared to the received message digest value 420 extracted by the message digest extractor 404. The message digest evaluator 410 determines if the truncated message digest value 426 is the same as the received truncated message digest value 420. If the values are not the same, the receiver 112 determines that the data 302 has been compromised, the data packet 312 is discarded and the system 100 is reset by initializing the forward cipher keys 308 (encryption key stream, decryption key stream) to a start vector using known techniques.

If the received truncated message digest value 420 is the same as the calculated truncated message digest value 426, the encrypted payload 310 is further processed as described below. If the message digest values 420 match and the session counts are not the same, the local session counter 412 is adjusted to reflect the appropriate session count.

The decryption engine 406 decrypts the padded encrypted data 302 using the forward cipher key 308. In the exemplary embodiment, the forward cipher key 308 used in the transmitter 106 is identical to the forward cipher key 308 used at the receiver 112. The forward cipher key 308 used at the transmitter 106 is referred to as an encryption key stream 308 and the forward cipher key 308 used at the receiver 112 is referred to as a decryption key stream. The continuous decryption key stream is a continuous forward cipher key 308 that is identical to the continuous forward cipher key 308 used as the continuous encryption key stream 308. The decryption engine 406 performs a reverse procedure to that of the encryption engine 306 in the transmitter 106 and in the exemplary embodiment utilizes RC4 techniques. After decryption, the pad remover 428 removes additional bits to reduce the size of the data 302 to its original size.

The functions of the padding engine 424, decryption engine 406 and pad remover 428 result in a utilization of a fixed and consistent length of a section of the decryption key stream (forward cipher key 308) independent of the length of the data string. By using the same length of the section of the decryption key stream (308) for each data packet 312, synchronization can be maintained by tracking the session count 331 (or packet count) and applying the appropriate section of decryption key stream (308) to each payload 310. Accordingly, if the session count 331 is known, the data packet 312 can be decrypted even if synchronization has previously been lost. Those skilled in the art will recognize that the padding engine 424, decryption engine 406 and pad remover 428 provide an exemplary description of functions producing the results described herein and other functional blocks can be used to explain the desired outcome. For example, the desired result of using sections of the forward cipher key 308 having a consistent length to encrypt each data packet 312 can be viewed as applying an appropriate number of bits of a constant length section of a forward cipher key 308 to a data payload and discarding the remainder of bits of the constant length section. In other words, the forward cipher key 308 is applied bit for bit to the encrypted payload 310 for all the bits in the encrypted payload 310. If the encrypted payload 310 is shorter than the maximum length section of forward cipher key 308, the additional cipher stream bits are not used and the next packet 312 is decrypted starting with the bit following the last bit in the maximum (fixed) length segment.

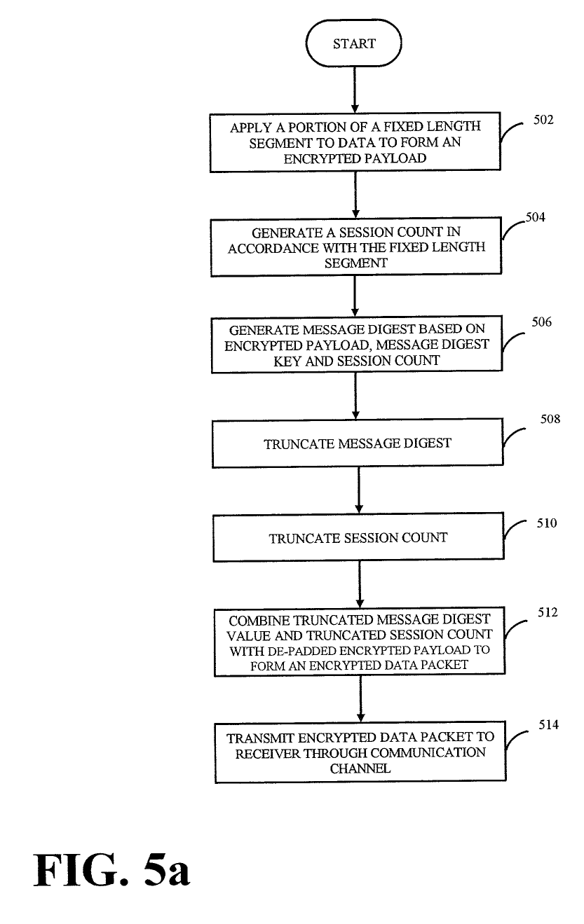

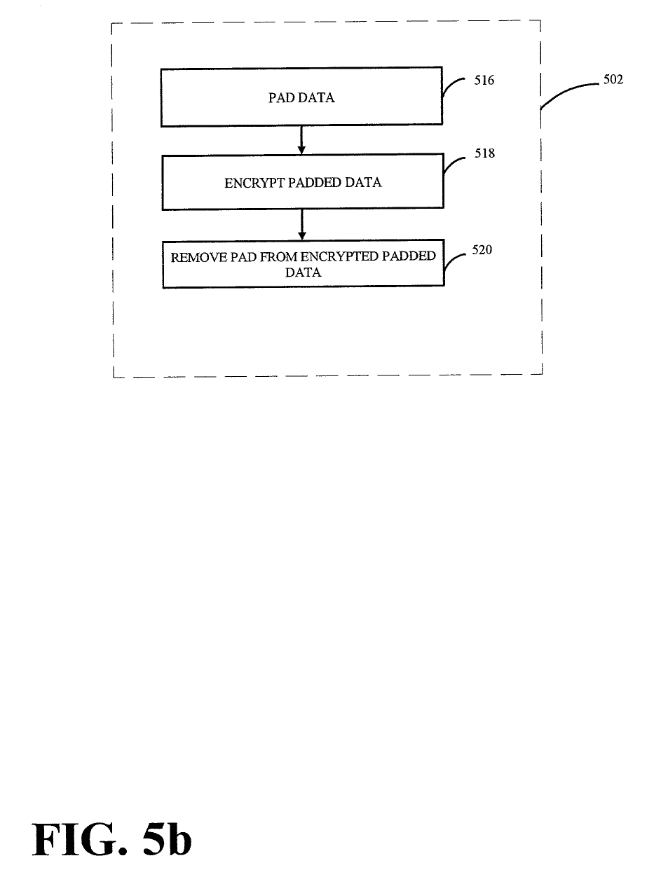

FIG. 5a is a flowchart of a method for validating the integrity of transmitted data 302 and maintaining synchronization performed in the transmitter 106. In the exemplary embodiment of the invention, the encryption and validation functions performed at the sending end of the communication system 100 are implemented using software code running on a processor within the transmitter 106. Other techniques, however, may be used to perform the method described in FIG. 5a and the systems 100 of FIGS. 3 and 4. The functions, for example, may be implemented using hardware, software, firmware or other combinations of similar techniques.

At step 502, a portion of the fixed length segment is applied to data 302 to form an encrypted payload 310. A fixed length segment of a continuous encryption key stream 308 is selected. In the exemplary embodiment, each fixed length segment is serially obtained from the continuous forward cipher key 308 used at the continuous encryption key stream 308. As explained in further detail in reference to FIG 5b, the encryption engine 306 encrypts the data by applying a maximum fixed length section of the encryption key stream 308 to the padded data 302. Since the encryption key stream 308 is applied bit by bit to the entire string of padded data 302, the data 302 is encrypted with only a portion of the fixed length section. The number of bits of the encryption key stream 308 needed to encrypt the data 302 can be applied to data and the remainder of the fixed length encryption key stream 308 can be discarded.

A session counter 324 generates a session count 331 in accordance with the fixed length segment at step 504. As explained above, the session count 331 may be a packet count. Accordingly, the session count 331 may be a unique value corresponding to the fixed length section of the encryption key stream 308.

At step 506, the message digest generator 304 generates a message based on the encrypted payload 310, the session count 331 and a message digest key 318.

At step 508, the message digest is truncated to form a truncated message digest 320. In the exemplary embodiment, the truncator 322 forms a truncated message digest value 320 by extracting the first four bytes of the current message digest 314. A suitable example, includes a message digest 314 having a length of 128 bits and a truncated message digest 320 having a length of 32 bits. Other bits in the bit stream may be retained as the truncated message digest value 320. For example, rather than the first four bits, the four bits at the end of the bit stream may be retained as the truncated message digest value 320.

At step 510, the session count 331 is truncated. As explained above, the truncator 322 truncates the session count 331 to a truncated session count 332. For example, if the session count 331 is 4 bytes long, the truncated session count 332 may include only the two least significant bytes of the session count 331.

The truncated message digest 320 and the truncated session count 332 are combined with the encrypted payload 310, at step 512, to form the encrypted data packet 312. In the exemplary embodiment, the truncated message digest 320 and the truncated session count 332 are attached to the de-padded encrypted payload 310 as a prefix. Other methods, however, may be used to combine the three values. For example, the truncated message digest value 320 or truncated session count 332 may be added as a suffix, or within a predetermined location within the encrypted data string of the de-padded encrypted payload 310. Further, in other embodiments the truncated message digest value 320 or truncated session count 332 may be distributed at multiple locations within the encrypted data packet 312.

At step 514, the encrypted data packet 312 is transmitted to the receiver 112 through the communication channel 102. The encrypted data packet 312 is modulated, amplified and transmitted through the communication channel 102 in accordance with known techniques and components.

FIG. 5b is a flow chart of an exemplary method of performing step 502. At step 516, the padding engine 326 pads data 302 to be transmitted by adding an appropriate number of bits to the data to create a data string having maximum and consistent size.

At step 518, the encryption engine 306 encrypts the resulting padded data. A fixed length section of the forward cipher key 308 is applied bit by bit to the maximum sized, padded data. In the exemplary embodiment, the encryption engine 306 uses RC4 cipher stream encryption techniques to apply the forward cipher key 308 to the padded data. An example of another encryption method includes performing an exclusive OR operation with the data 302 and the encryption key stream 308.

At step 520, the pad remover 328 removes the pad from the encrypted padded data 320 to produce de-padded encrypted data 330. The results of steps 512 through 516 can be accomplished in variety of ways. For example, the portion of the required number bits of the segment of encryption key stream 308 can be applied to the data 302 and the remainder of bits not needed for encryption can be discarded. Therefore, the entire fixed length section of the encryption key stream 308 is devoted to the data. 302 even though the data 302 may have a length less than the maximum size.

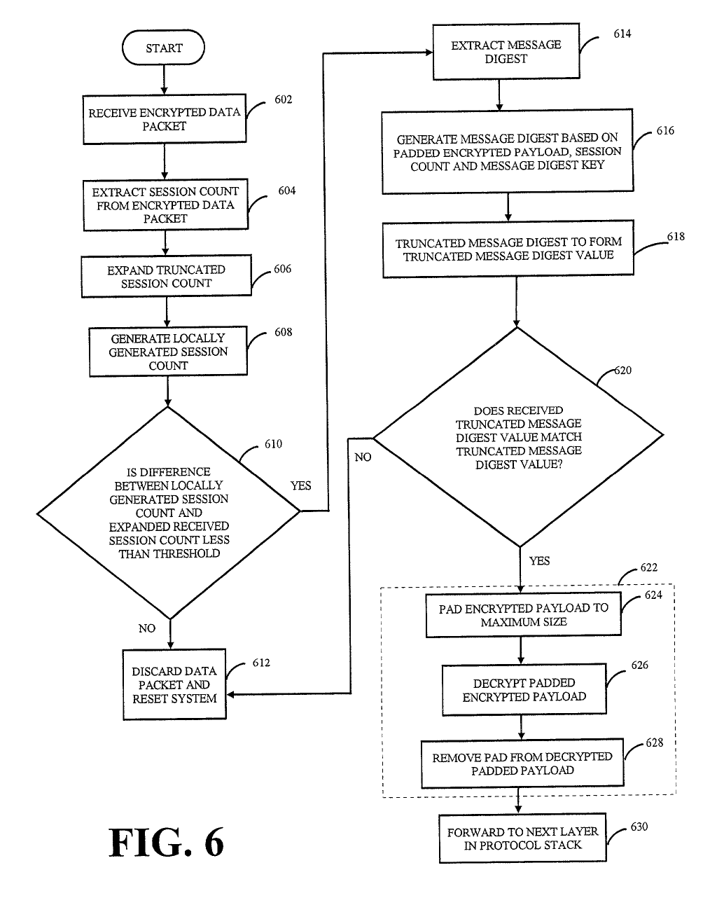

FIG. 6 is a flow chart of a method performed at the receiver 112 of validating received data 302 transmitted through the communication channel 102 and maintaining synchronization between the encryption key stream 308 and the decryption key stream 308.

At step 602, the encrypted data packet 312 is received through the communication channel 102.

At step 604, the session count 331 is extracted from the encrypted data packet 312. In the exemplary embodiment, the session count 331 is represented by a truncated session count 332 as explained above.

At step 606, the truncated session count 332 is expanded to the full length session count. In the exemplary embodiment, the most significant bits maintained by a locally generated session count are appended to the truncated session count 332 which includes the least significant bits of the session count 331 generated at the transmitter 106 and received at the receiver 108.

At step 608, a locally generated session count is generated by the session counter 412 in the receiver 112.

At step 610, it is determined whether the difference between the locally generated session count and the session count 332 received within the encrypted data packet 312 is less than a threshold. If the difference is not less, the data packet 312 is discarded at step 612 and the system 100 is reset. If the difference is less, the method continues at step 614.

At step 614, the truncated message digest value 420 is extracted from the encrypted data packet 312. In the exemplary embodiment, the data packet 312 includes the truncated message digest 320 and the de-padded encrypted payload 310. Accordingly, extracting the message digest 420 reveals the received encrypted payload 310.

At step 616, a message digest is generated based on the encrypted padded data 302, the session count 332 and a message digest key 318. The message digest generator 404 generates the message digest using the message digest key 318, the output of the padding engine 326, and the full session count 331 as expanded by the session count expander 416.

At step 618, the message digest is truncated. In the exemplary embodiment, the truncator 422 truncates the message digest by extracting the first four bytes of the message digest to produce the truncated message digest 426.

At step 620, the received truncated message digest value 320 is compared to the truncated message digest value 426. If the received message digest 320 does not match the locally generated message digest 426, the data packet 312 is discarded and the system 100 is reset at step 612. At step 612, the decryption key is re-synchronized to the encryption key by setting the decryption key and the encryption key to a start vector. If the values match, the method continues at step 622.

At step 622, the de-padded encrypted payload 310 of the data packet 312 is decrypted by applying a portion of a fixed length segment of a continuous decryption key stream 308 to the de-padded encrypted payload 310 of the encrypted data packet 312. The fixed length segment is based on the received truncated session count 332 of a received data packet 312. In the exemplary embodiment, step 622 includes step 624-628 which are described immediately below. Other methods, however, of applying a portion of a fixed length segment of a continuous decryption key stream 308 to the encrypted payload 310 of the encrypted data packet 312 can be used.

At step 624, the de-padded encrypted payload 310 is padded to the maximum size. The padding engine 424 adds an appropriate number of bits to the encrypted payload 310 to form a data string of a maximum, fixed length. For example, a series of “1”s can be appended to the encrypted payload 310.

At step 626, the encrypted padded payload is decrypted to form a decrypted padded payload. The fixed length segment corresponding to the current session count is applied by the decryption engine 406 to the encrypted padded payload. In the exemplary embodiment, the decryption engine 406 performs a bit per bit streaming encryption process. As explained above, examples of suitable decryption techniques include RC4 and exclusive OR decryption methods.

At step 628, the pad is removed from the decrypted padded payload. The pad remover 428 discards the appropriate number of bits from the padded decrypted payload to reduce the payload to the original size prior to padding and encryption in the transmitter.

At step 630, the decrypted data packet 312 is forwarded to the appropriate layer (202-208) within the protocol stack for further processing in accordance with the particular communication system 100.

Therefore, synchronization between the key streams at the transmitter and receiver is maintained by tracking the session count and utilizing a fixed length segment of the key streams for each data packet regardless of the size of the data payload. Clearly, other embodiments and modifications of this invention will occur readily to those of ordinary skill in the art in view of these teachings. Therefore, this invention is to be limited only by following claims, which include all such embodiments and modifications when viewed in conjunction with the above specification and accompanying drawings.

We claim:

1. A method comprising:
selecting a fixed length segment of a continuous decryption key stream based on a received session count of a data packet; and
decrypting a payload of the data packet by applying a portion of the fixed length segment to the data packet.

2. A method in accordance with claim 1, wherein the applying comprises performing a bit per bit streaming encryption process.

3. A method in accordance with claim 2, wherein the applying further comprises performing an exclusive OR operation with the portion of the fixed length segment and the data packet.

4. A method in accordance with claim 2, wherein the applying further comprises performing an RC4 operation with the portion of the fixed length segment and the data packet.

5. A method in accordance with claim 2, further comprising:
receiving the data packet, the data packet comprising at least a portion of the received session count.

6. A method in accordance with claim 5, wherein the data packet further comprises at least a portion of a received message digest value.

7. A method in accordance with claim 5, wherein the selecting comprises:
selecting a current fixed length segment if a difference between the received session count and a locally generated session count is less than a threshold value.

8. A method in accordance with claim 7, wherein the selecting further comprises:
extracting the at least a portion of the received session count from the encrypted data packet;
expanding the at least a portion of the received session count to the received session count; and
comparing the received session count to the locally generated session count.

9. A method in accordance with claim 8, further comprising:
discarding the data packet if the difference is not less than the threshold value.

10. A method in accordance with claim 9, further comprising:
re-synchronizing a decryption key to an encryption key by setting the decryption key and the encryption key to a start vector if the difference in not less than the threshold value.

11. A method in accordance with claim 6, further comprising:
discarding the data packet if the at least a portion of the received message digest value does not match a locally generated message digest value.

12. A method in accordance with claim 11, further comprising:
re-synchronizing the decryption key to an encryption key by setting the decryption key and the encryption key to a start vector if the at least a portion of the received message digest value does not match the locally generated message digest value.

13. A method in accordance with claim 12, further comprising:
extracting the at least a portion of the received message digest value from the data packet;
generating the locally generated message digest value based on the at least a portion of the received session count, a received encrypted payload of the data packet and a message digest key;
truncating the locally generated message digest value to form a truncated message digest; and
comparing the truncated message digest to the at least a portion of the received message digest value.

14. A method of generating an encrypted data packet, the method comprising:
selecting a fixed length segment of a continuous encryption key stream;
applying a portion of the fixed length segment to data to form an encrypted payload;
generating a session count based in accordance with the fixed length segment; and
combining the encrypted payload and the at least a portion of the session count to form an encrypted data packet.

15. A method in accordance with claim 14, wherein the applying comprises performing a bit per bit streaming encryption process.

16. A method in accordance with claim 15, wherein the applying further comprises performing an exclusive OR operation with the portion of the fixed length segment and the data packet.

17. A method in accordance with claim 15, wherein the applying further comprises performing an RC4 operation with the portion of the fixed length segment and the data packet.

18. A method in accordance with claim 14, further comprising:
generating a message digest value; and
combining at least a portion of the message digest value with the encrypted payload to form the encrypted data packet.

19. A method in accordance with claim 18, wherein the generating comprises:
generating the message digest value based on the encrypted payload, the session count and a message digest key.

20. A method in accordance with claim 18, further comprising:
forming the at least a portion of the message digest value by truncating the message digest value.

21. A method in accordance with claim 14, further comprising transmitting the encrypted data packet to a receiver through a communication channel.

22. A method in accordance with claim 14, further comprising:
receiving a received data packet corresponding to the encrypted data packet, the received data packet comprising the encrypted payload, at least a portion of a received session count and a received truncated message digest value;
selecting a fixed length segment of a continuous decryption key stream based on a received session count of a data packet; and
decrypting a payload of the data packet by applying a portion of the fixed length segment to the data packet.

23. A method in accordance with claim 22, wherein the applying comprises performing a bit per bit streaming decryption process.

24. A method in accordance with claim 22, wherein the applying further comprises performing an exclusive OR operation with the portion of the fixed length segment and the data packet.

25. A method in accordance with claim 22, wherein the applying further comprises performing an RC4 operation with the portion of the fixed length segment and the data packet.

26. A method in accordance with claim 25, wherein the selecting the fixed length segment of the continuous decryption key stream comprises:
selecting a current fixed length segment if a difference between the received session count and a locally generated session count is less than a threshold value.

27. A method in accordance with claim 26, wherein the selecting further comprises:
extracting the at least a portion of the received session count from the received encrypted data packet;
expanding the at least a portion of the received session count to the received session count; and
comparing the received session count to the locally generated session count.

28. A method in accordance with claim 27, further comprising:
discarding the received encrypted data packet if the difference is not less than the threshold value.

29. A method in accordance with claim 28, further comprising:
re-synchronizing the decryption key to the encryption key by setting the decryption key and the encryption key to a start vector if the difference in not less than the threshold value.

30. A method in accordance with claim 26, further comprising:
discarding the received encrypted data packet if the received truncated message digest value does not match a truncated locally generated message digest value.

31. A method in accordance with claim 30, further comprising:
re-synchronizing the decryption key stream to an encryption key stream by setting the decryption key stream and the encryption key stream to a start vector if the at least a portion of the received message digest value does not match the locally generated message digest value.

32. A method in accordance with claim 31, further comprising:
extracting the received truncated message digest value from the received encrypted data packet;
generating a locally generated message digest value based on the at least a portion of the session count, a received encrypted payload of the data packet and a message digest key;
truncating the locally generated message digest value to form the locally generated truncated message digest value; and
comparing the locally generated truncated message digest value to the received truncated message digest value.

33. A receiver comprising:
a session count evaluator configured to determine if a difference between a received session count within a received encrypted data packet and a locally generated session count is less than a threshold; and
a decryption engine configured to decrypt a payload of the received encrypted data packet by applying a portion of a current fixed length segment of a continuous decryption key stream to the data packet if the difference is less than the threshold.

34. A receiver in accordance with claim 33, wherein the decryption engine is further configured to perform a bit per bit streaming encryption process.

35. A receiver in accordance with claim 34, wherein the decryption engine is further configured to perform an exclusive OR operation with the portion of the fixed length segment and the data packet.

36. A receiver in accordance with claim 34, wherein the decryption engine is further configured to perform an RC4 operation with the portion of the fixed length segment and the data packet.

37. A receiver in accordance with claim 33, wherein the received encrypted data packet comprises at least a portion of the session count.

38. A receiver in accordance with claim 37, further comprising:
a session count extractor configured to extract the at least a portion of the received session count from the received encrypted data packet; and
a session count expander configured to expand the at least a portion of the received session count to the received session count.

39. A receiver in accordance with claim 38, wherein the received encrypted data packet further comprises at least a portion of a received message digest value.

40. A receiver in accordance with claim 39, further comprising:
a message digest extractor configured to extract the at least a portion of the received message digest value from the received encrypted data packet;
a message digest generator configured to generate a locally generated message digest value based on the at least a portion of the session count, a received encrypted payload of the data packet and a message digest key;
a truncator configured to truncate the locally generated message digest value to form a truncated message digest; and
a message digest evaluator configured to compare the truncated message digest value to the at least a portion of the received message digest value, wherein the receiver is configured to discard the received encrypted data packet if the truncated message digest value does not match the at least a portion of the received message digest value.

41. A transmitter configured to generate an encrypted data packet, the transmitter comprising:
an encryption engine configured to apply a portion of a fixed length segment of a continuous encryption key stream to data to form an encrypted payload;
a session count generator configured to generate a packet number in accordance with the fixed length segment, the encrypted data packet comprising the encrypted payload and at least a portion of the session count.

42. A transmitter in accordance with claim 41, wherein the encryption engine is configured to perform a bit per bit streaming encryption process.

43. A transmitter in accordance with claim 42, wherein the encryption engine is further configured to perform an exclusive OR operation with the portion of the fixed length segment and the data packet.

44. A transmitter in accordance with claim 42, wherein the encryption engine is further configured to perform an RC4 operation with the portion of the fixed length segment and the data packet.

45. A transmitter in accordance with claim 42, further comprising:
a message digest generator configured to generate a message digest value, the encrypted data packet comprising at least a portion of the message digest value.

46. A transmitter in accordance with claim 45, wherein the message digest generator is further configured to generate the message digest value based on the encrypted payload, the session count and a message digest key.

47. A transmitter in accordance with claim 46, further comprising:
a truncator configured to truncate the message digest value to form the at least a portion of the message digest value.

48. A system comprising:
a transmitter configured to generate an encrypted data packet, the transmitter comprising:
an encryption engine configured to apply a portion of a fixed length segment of a continuous encryption key stream to data to form an encrypted payload;
a session count generator configured to generate a session count in accordance with the fixed length segment; the encrypted data packet comprising the encrypted payload and at least a portion of the session count; and
a receiver configured to receive the encrypted data packet, the receiver comprising:
a session count evaluator configured to determine if a difference between a received session count within the encrypted data packet and a locally generated session count is less than a threshold; and
a decryption engine configured to decrypt the encrypted payload by applying a portion of a current fixed length segment of a continuous decryption key stream to the data packet if the difference is less than the threshold.

49. A method comprising:
receiving a data packet through a communication channel; the data packet comprising at least a portion of a session count;
selecting a fixed length segment of a continuous decryption key stream based on the session count; and
applying a portion of the fixed length segment by performing a bit per bit streaming encryption to decrypt a payload of the data packet.

50. A method in accordance with claim 49, wherein the selecting comprises:
selecting a current fixed length segment if a difference between the received session count and the locally generated session count is less than a threshold value.

51. A method in accordance with claim 50, wherein the selecting further comprises:
extracting the at least a portion of the received session count from the encrypted data packet;
expanding the at least a portion of the received session count to the received session count; and
comparing the received session count to the locally generated session count.

52. A method in accordance with claim 51, further comprising:
discarding the data packet if the difference is not less than the threshold value.

53. A method of generating an encrypted data packet, the method comprising:
selecting a fixed length segment of a continuous encryption key stream;
applying a portion of the fixed length segment to data by performing a bit per bit streaming encryption process to form an encrypted payload;
generating a session count in accordance with the fixed length segment; and
combining the encrypted payload and the at least a portion of the session count to form an encrypted data packet.
